(19) United States
(12) Patent Application Publication
(10) Pub. No.: US 2006/0061703 A1
(43) Pub. Date: Mar. 23, 2006

(54) Liquid crystal display panel device with a removable reinforced protective transparent panel

(75) Inventor: Lin-Ming Chen, Kuei Shan Hsiang (TW)

Correspondence Address: LINIAK, BERENATO & WHITE, Suite 240, 6550 Rock Spring Drive, Bethesda, MD, 20817-1132, US

(73) Assignee: CHI LIN TECHNOLOGY CO., LTD.

(21) Appl. No.: 10/943,884

(22) Filed: Sep. 20, 2004

(51) Int. Cl. G02F 1/1333

(52) U.S. Cl. 349/58

(57) ABSTRACT

A liquid crystal display panel device includes a face panel unit, a reinforced protective transparent panel, and an engaging unit. The face panel unit includes a hollow panel base, front and rear transparent electrode layers disposed in the panel base, and a liquid crystal active layer disposed in the panel base between the front and rear transparent electrode layers and operably associated with the front and rear transparent electrode layers. The reinforced protective transparent panel is disposed in front of the face panel unit and parallel to the front transparent electrode layer, and serves to protect the face panel unit. The reinforced protective transparent panel has at least one pair of opposing peripheral portions. The engaging unit retains removably the peripheral portions of the reinforced protective transparent panel on the panel base.

### BACKGROUND OF THE INVENTION

1. Field of the Invention

The invention relates to a display panel device, more particularly to a liquid crystal display panel device with a removable reinforced protective transparent panel.

2. Description of the Related Art

As shown in FIG. 1, a conventional liquid crystal display panel device 1 includes a hollow panel base 11, front and rear transparent electrode layers 13, 12 disposed in the panel base 11, and a liquid crystal active layer 14 disposed in the panel base 11 between the front and rear transparent electrode layers 13, 12 and operably associated with the front and rear transparent electrode layers 13, 12 for presenting images in a manner well known in the art.

It is known that the liquid crystal active layer 14 is quite fragile. Therefore, to protect the liquid crystal display panel device 1 from damage, a reinforced protective transparent panel 15, such as a reinforced glass panel, is disposed in front of the front transparent electrode layer 13 and is secured to the panel base 11. In the prior art, strips 16 of double-sided adhesive tape are used to fix the periphery of the reinforced protective transparent panel 15 to the panel base 11. However, although the double-sided adhesive tape provides a sufficient force for fixing the reinforced protective transparent panel 15 to the panel base 11, the adhesive tape does not make it possible for repair personnel to remove the reinforced protective transparent panel 15 from the panel base 11 when it is desired to conduct repair and maintenance of the liquid crystal display panel device 1.

### SUMMARY OF THE INVENTION

Therefore, the object of the present invention is to provide a liquid crystal display panel device that is provided with a removable reinforced protective transparent panel so as to overcome the aforesaid drawbacks of the prior art.

According to one aspect of the present invention, there is provided a liquid crystal display panel device that comprises a face panel unit, a reinforced protective transparent panel, and an engaging unit.

The face panel unit includes a hollow panel base, front and rear transparent electrode layers disposed in the panel base, and a liquid crystal active layer disposed in the panel base between the front and rear transparent electrode layers and operably associated with the front and rear transparent electrode layers.

The reinforced protective transparent panel is disposed in front of the face panel unit and parallel to the front transparent electrode layer, and serves to protect the face panel unit. The reinforced protective transparent panel has at least one pair of opposing peripheral portions.

The engaging unit includes at least two engaging members provided on at least two opposite sides of the panel base, each of which retains removably a respective one of the peripheral portions of the reinforced protective transparent panel on the panel base.

According to another aspect of the present invention, there is provided a liquid crystal display panel device that comprises a face panel unit, a reinforced protective transparent panel, and an engaging unit.

The face panel unit includes a hollow panel base, front and rear transparent electrode layers disposed in the panel base, and a liquid crystal active layer disposed in the panel base between the front and rear transparent electrode layers and operably associated with the front and rear transparent electrode layers.

The reinforced protective transparent panel is disposed in front of the face panel unit and parallel to the front transparent electrode layer, and serves to protect the face panel unit. The reinforced protective transparent panel has at least one pair of opposing peripheral portions.

The engaging unit is formed integrally on the peripheral portions of the reinforced protective transparent panel, and engages removably the panel base.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary schematic sectional view of a conventional liquid crystal display panel device;

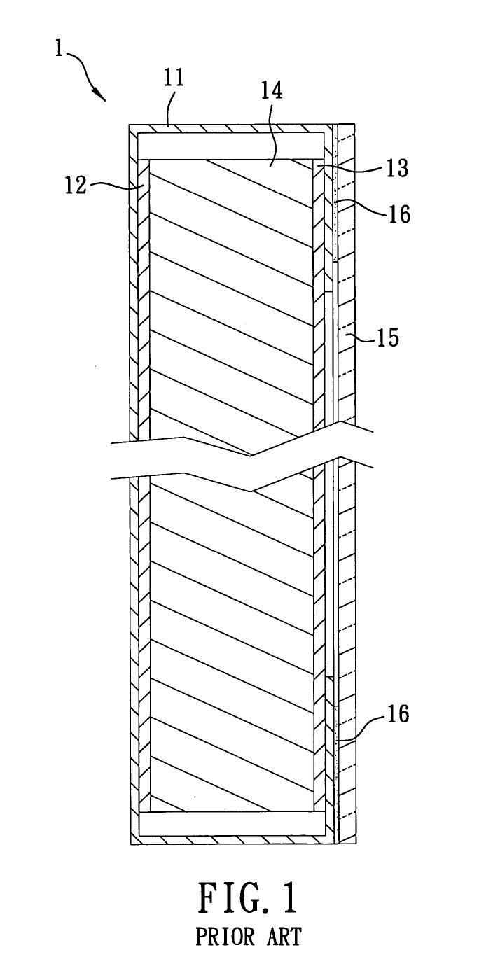

FIG. 2 is a fragmentary schematic sectional view of the first preferred embodiment of a liquid crystal display panel device according to the present invention;

FIG. 3 is a fragmentary, partly exploded, perspective view of the first preferred embodiment;

FIG. 4 is a front schematic view of the first preferred embodiment;

FIG. 5 is a front schematic view of the second preferred embodiment of a liquid crystal display panel device according to the present invention;

FIG. 6 is a front schematic view of the third preferred embodiment of a liquid crystal display panel device according to the present invention;

FIG. 7 is a fragmentary, partly exploded, perspective view of the fourth preferred embodiment of a liquid crystal display panel device according to the present invention;

FIG. 8 is a fragmentary schematic sectional view of the fourth preferred embodiment;

FIG. 9 is a magnified view of a portion of the fourth preferred embodiment of FIG. 8;

FIG. 10 is a view similar to FIG. 9, illustrating a modification of the fourth preferred embodiment;

FIG. 11 is a view similar to FIG. 9, illustrating another modification of the fourth preferred embodiment;

FIG. 12 is a fragmentary schematic sectional view of the fifth preferred embodiment of a liquid crystal display panel device according to the present invention;

FIG. 13 is a partly exploded, perspective view of the sixth preferred embodiment of a liquid crystal display panel device according to the present invention; and

FIG. 14 is a fragmentary schematic sectional view of the seventh preferred embodiment of a liquid crystal display panel device according to the present invention.

### DETAILED DESCRIPTION OF THE PREFERRED EMBODIMENTS

Before the present invention is described in greater detail with reference to the preferred embodiments, it should be noted herein that like elements are denoted by the same reference numerals through the accompanying disclosure.

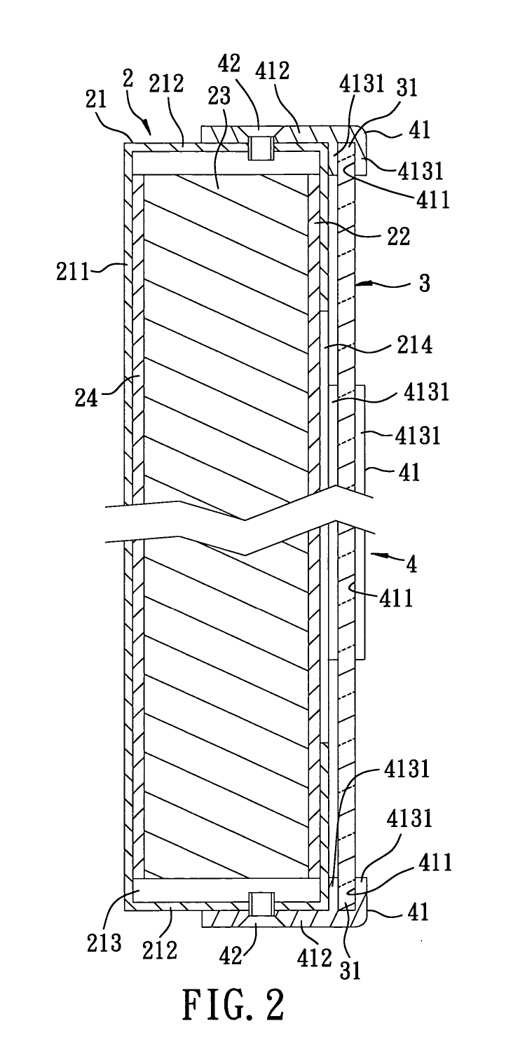

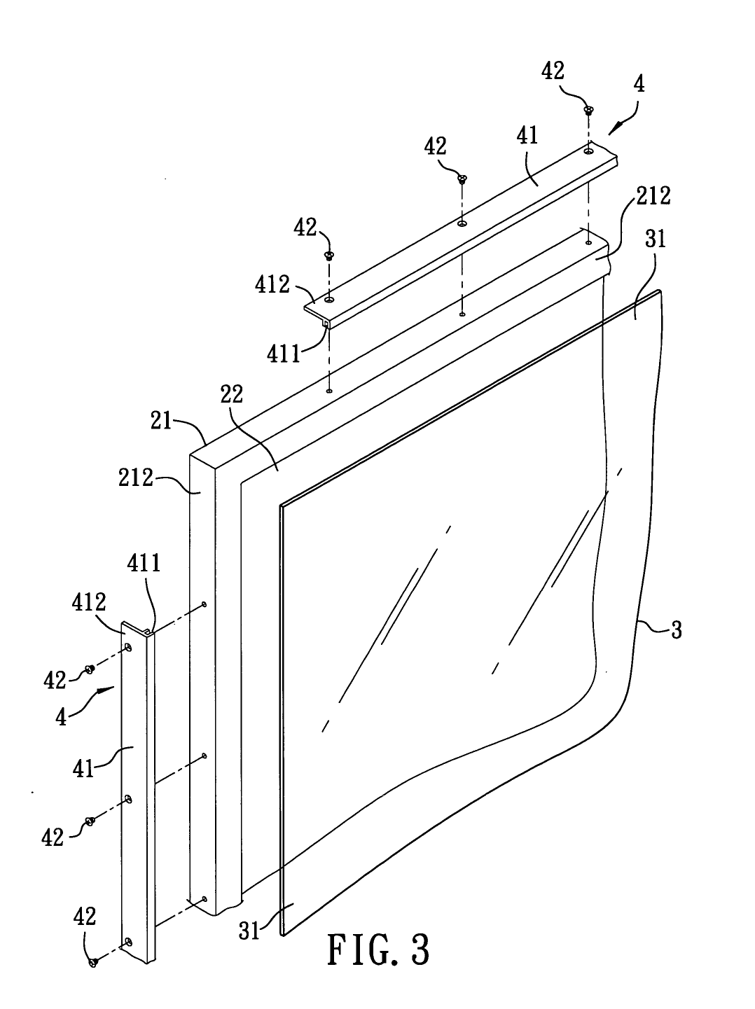

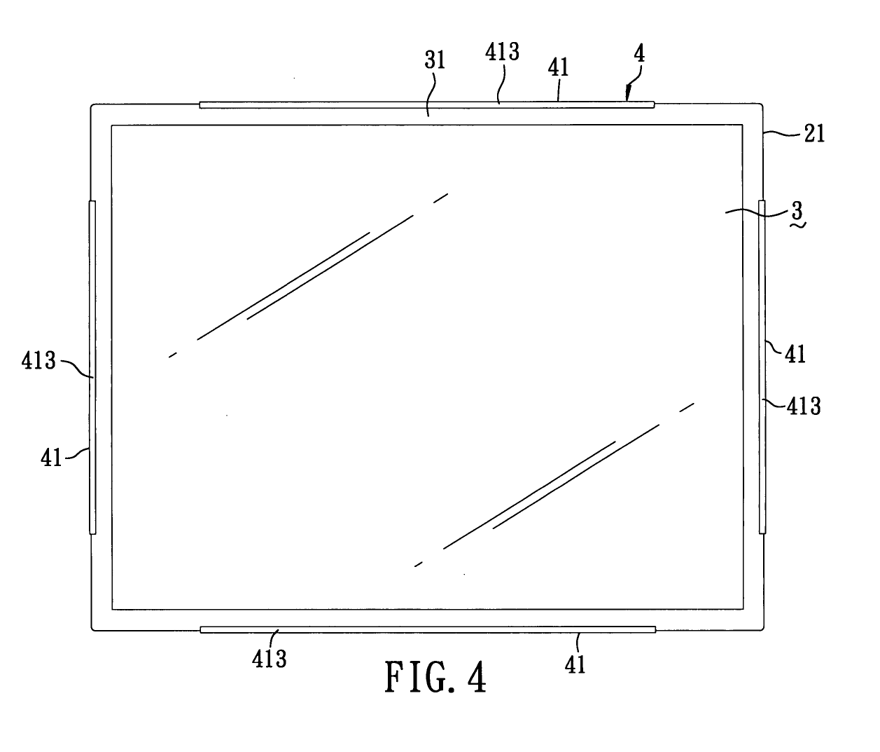

Referring to FIGS. 2, 3 and 4, the first preferred embodiment of a liquid crystal display panel device according to the present invention is shown to comprise a face panel unit 2, a reinforced protective transparent panel 3, and an engaging unit 4.

The face panel unit 2 includes a hollow panel base 21 having a rectangular base plate 211 and four frame plates 212 that extend respectively from four lateral edges of the base plate 211. The four frame plates 212 cooperate with the base plate 211 to configure the panel base 21 with an assembly space 213 and a viewing window 214.

The face panel unit 2 further includes front and rear transparent electrode layers 22, 24 disposed in the assembly space 213 of the panel base 21, and a liquid crystal active layer 23 disposed in the assembly space 213 of the panel base 21 between the front and rear transparent electrode layers 22, 24 and operably associated with the front and rear transparent electrode layers 22, 24 for presenting images that are visible via the viewing window 214 in a known manner. Since the operating relationship of the liquid crystal active layer 23 with the front and rear transparent electrode layers 22, 24 is well known in the art and is not pertinent to the claimed invention, a detailed description of the same is omitted herein for the sake of brevity.

The reinforced protective transparent panel 3 is disposed in front of the face panel unit 2 and parallel to the front transparent electrode layer 22, and serves to protect the face panel unit 2. In this embodiment, the reinforced protective transparent panel 3 is made of glass, is rectangular in shape, and has upper, lower, left and right peripheral portions 31.

The engaging unit 4 serves to retain removably the peripheral portions 31 of the reinforced protective transparent panel 3 on the panel base 21. In this embodiment, the engaging unit 4 includes upper, lower, left and right engaging members 41, each of which is provided on a respective one of the frame plates 212 of the panel base 21, and each of which engages removably a respective one of the peripheral portions 31 of the reinforced protective transparent panel 3. In particular, each of the engaging members 41 is formed with a retaining groove 411 to engage the respective one of the peripheral portions 31 of the reinforced protective transparent panel 3.

In this embodiment, each of the engaging members 41 has a mounting portion 412 mounted to a respective one of the frame plates 212 of the panel base 21, and a retaining portion 413 that extends from the mounting portion 412 and that is formed with the retaining groove 411. Screw fasteners 42 are provided to mount removably the mounting portions 412 of the engaging members 41 to the frame plates 212 of the panel base 21. The retaining portion 413 includes a pair of retaining plates 4131 that define the retaining groove 411 therebetween.

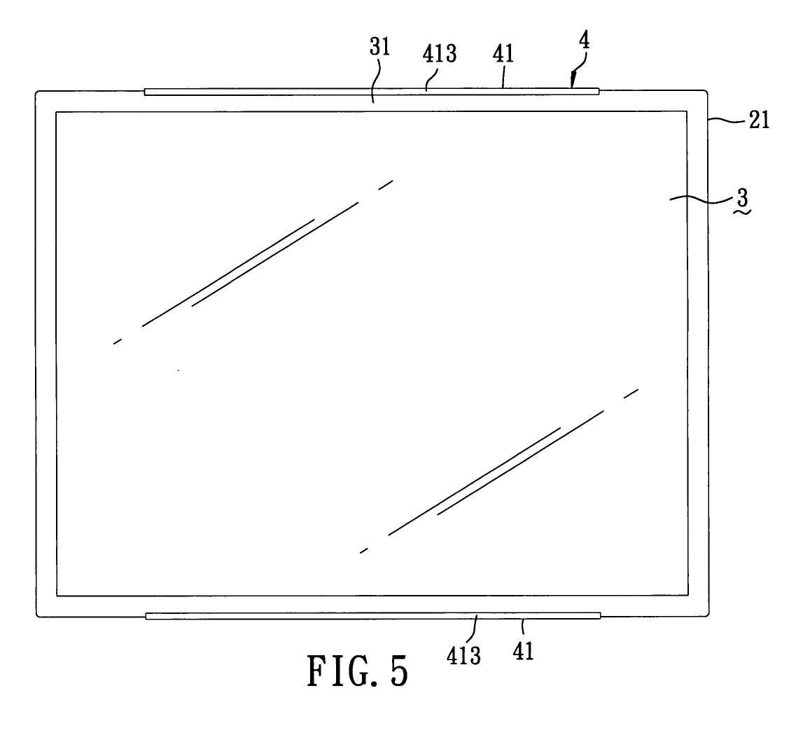

As shown in FIG. 5, the second preferred embodiment of this invention is similar to the first preferred embodiment, the main difference residing in that the engaging unit 4 only includes upper and lower engaging members 41 for retaining removably the upper and lower peripheral portions 31 of the reinforced protective transparent panel 3 on the panel base 21.

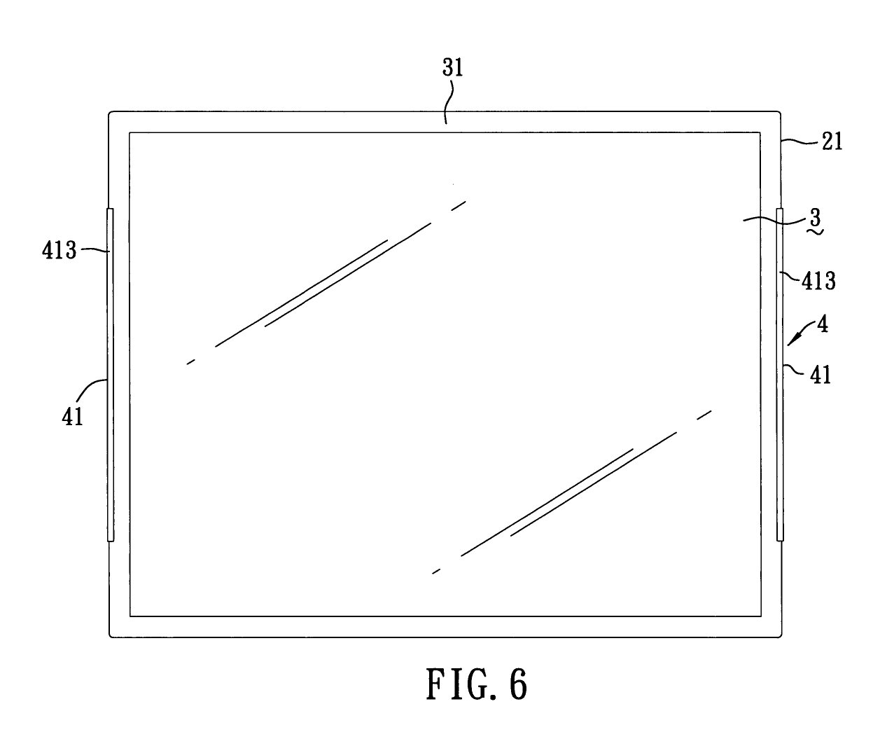

As shown in FIG. 6, the third preferred embodiment of this invention is similar to the first preferred embodiment, the main difference residing in that the engaging unit 4 only includes left and right engaging members 41 for retaining removably the left and right peripheral portions 31 of the reinforced protective transparent panel 3 on the panel base 21.

In yet another embodiment, the engaging unit 4 can include only three engaging members 41 for retaining removably three, such as the lower, left and right peripheral portions 31, of the reinforced protective transparent panel 3 on the panel base 21.

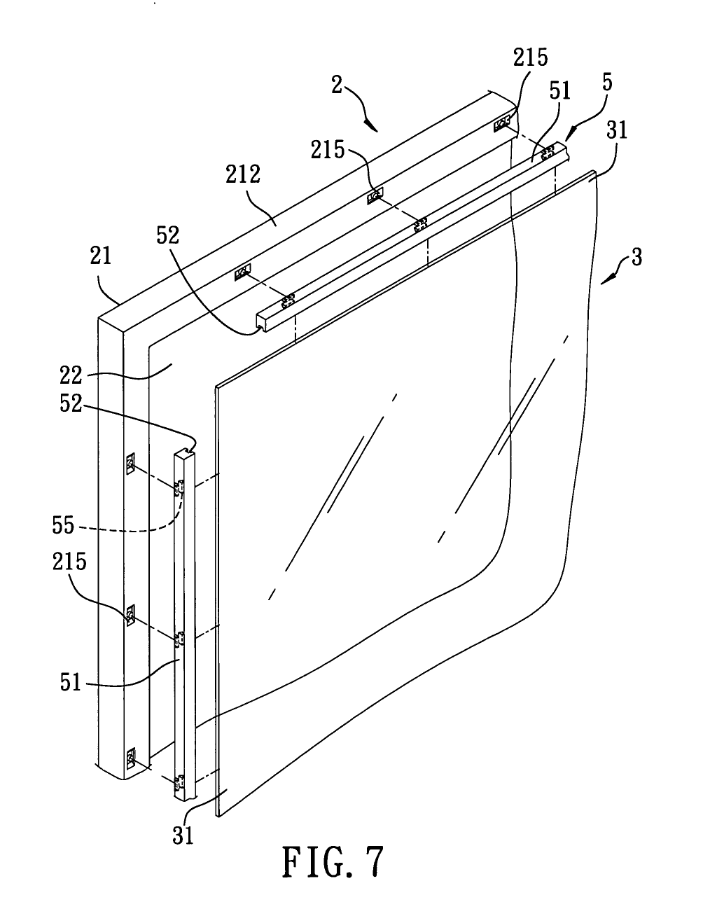

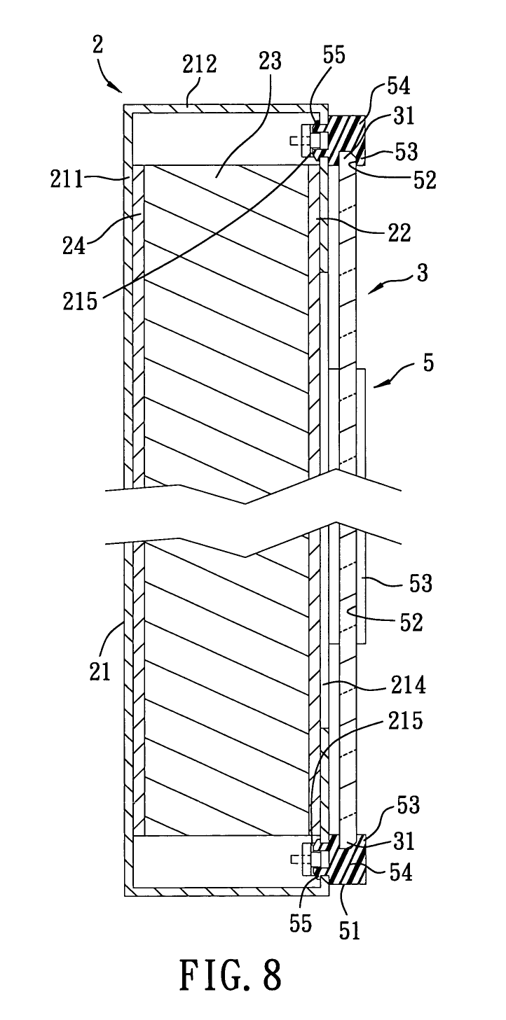

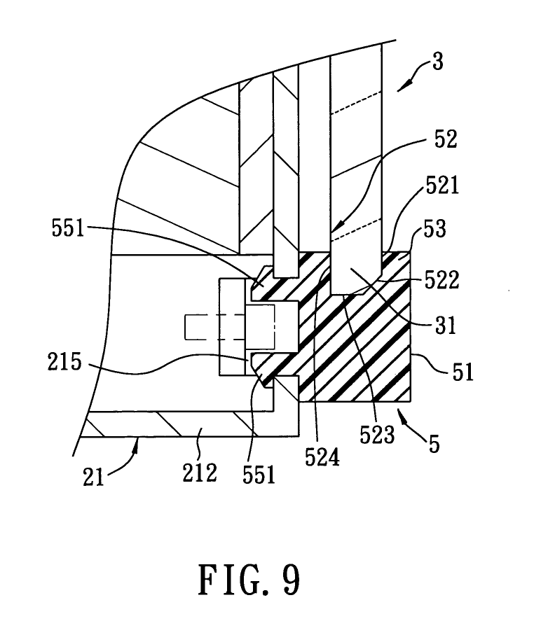

As shown in FIGS. 7 and 8, the fourth preferred embodiment of this invention differs from the first preferred embodiment primarily in the configuration of the engaging unit 5. In this embodiment, each of the engaging members 51 of the engaging unit 5 includes a connecting portion 54, a retaining portion 53 that extends from the connecting portion 54 and that is formed with the retaining groove 52, and a set of resilient anchoring portions 55 that extend from the connecting portion 54 and that engage the panel base 21. In this embodiment, each resilient anchoring portion 55 includes a pair of spring arms 551, each of which has a distal barb end to engage removably the panel base 21, as best shown in FIG. 9. However, it should be noted that a resilient anchoring portion having only one spring arm is also sufficient to provide the function of retaining the respective engaging member 51 on the panel base 21.

In this embodiment, the frame plates 212 of the panel base 21 are each formed with a respective set of engaging holes 215 to engage the resilient anchoring portions 55 of the engaging members 51. The engaging holes 215 are formed by punching during the manufacture of the panel base 21, and can be used to receive screw fasteners therein. The engaging members 51 are preferably made of a soft plastic material to enhance resiliency of the spring arms 551.

Referring to FIGS. 9, 10 and 11, the shape of the retaining groove 52 is not limited to a rectangle, and can be modified to suit different requirements. As shown in FIG. 9, the retaining groove 52 has a non-rectangular shape and is defined by a first inner wall surface 521, a second inner wall surface 522 extending inclinedly from the first inner wall surface 521, a third inner wall surface 523 extending from the second inner wall surface 522 and transverse to the first inner wall surface 521, and a fourth inner wall surface 524 extending from the third inner wall surface 523 and parallel to the first inner wall surface 521.

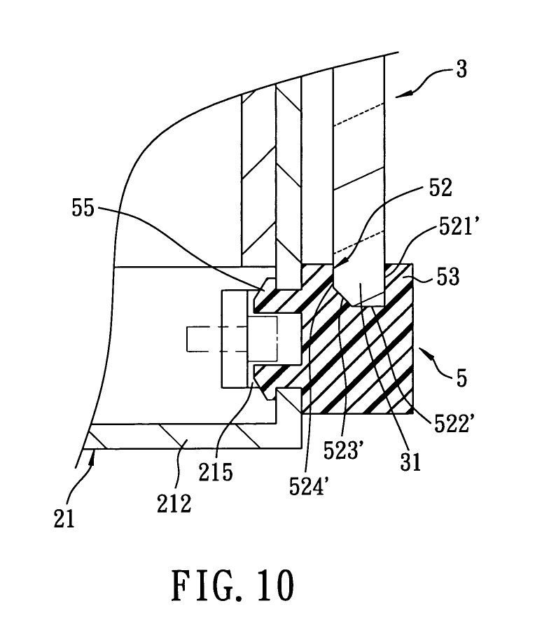

As shown in FIG. 10, the retaining groove 52 has a non-rectangular shape and is defined by a first inner wall surface 521′, a second inner wall surface 522′ extending from and transverse to the first inner wall surface 521′, a third inner wall surface 523′ extending inclinedly from the second inner wall surface 522′, and a fourth inner wall surface 524′ extending from the third inner wall surface 523′ and parallel to the first inner wall surface 521′.

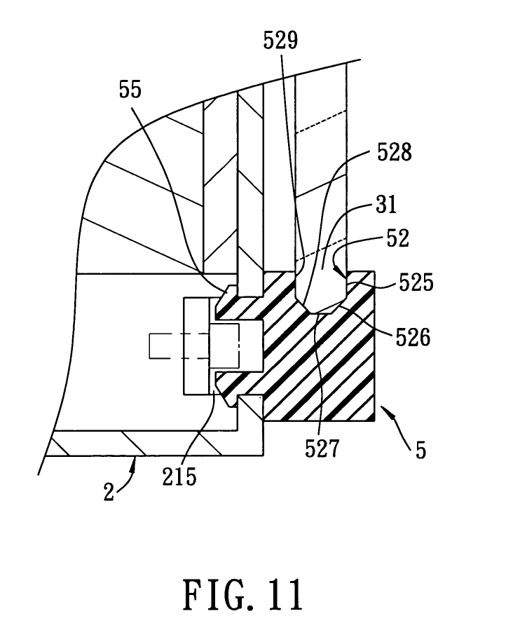

As shown in FIG. 11, the retaining groove 52 has a non-rectangular shape and is defined by a first inner wall surface 525, a second inner wall surface 526 extending inclinedly from the first inner wall surface 525, a third inner wall surface 527 extending from the second inner wall surface 526 and transverse to the first inner wall surface 525, a fourth inner wall surface 528 extending inclinedly from the third inner wall surface 527 and disposed opposite to the second inner wall surface 526, and a fifth inner wall surface 529 extending from the fourth inner wall surface 528 and parallel to the first inner wall surface 525.

In order to improve retention, the inner wall surfaces of the retaining grooves 411, 52 in the first to fourth preferred embodiments may be coated with a fibrous agent to increase traction with the reinforced protective transparent panel 3.

As shown in FIGS. 2, 3 and 4, to repair or maintain the liquid crystal display device of the first to third preferred embodiments, it is only required to unscrew the screw fasteners 42 so as to remove the engaging members 41 from the panel base 21, thereby resulting in removal of the reinforced protective transparent panel 3. In the fourth preferred embodiment, a tool is needed to pry the resilient anchoring portions 55 from the engaging holes 215, thereby removing the engaging members 51 from the panel base 21 to result in removal of the reinforced protective transparent panel 3.

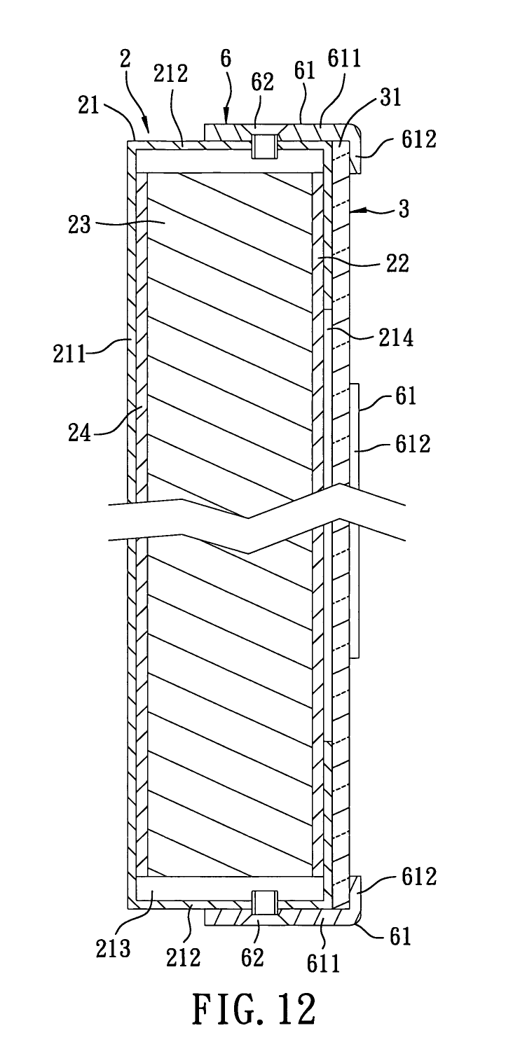

As shown in FIG. 12, the fifth preferred embodiment of this invention differs from the first preferred embodiment primarily in the configuration of the engaging unit 6. In this embodiment, each of the engaging members 61 of the engaging unit 6 has a mounting portion 611 mounted to the panel base 21, and a retaining portion 612 that extends transversely from the mounting portion 611 and that presses the respective one of the peripheral portions 31 of the reinforced protective transparent panel 3 against the panel base 21. Screw fasteners 62 are provided to mount removably the mounting portions 612 of the engaging members 61 to the frame plates 212 of the panel base 21. To remove the reinforced protective transparent panel 3, the screw fasteners 62 are simply unscrewed.

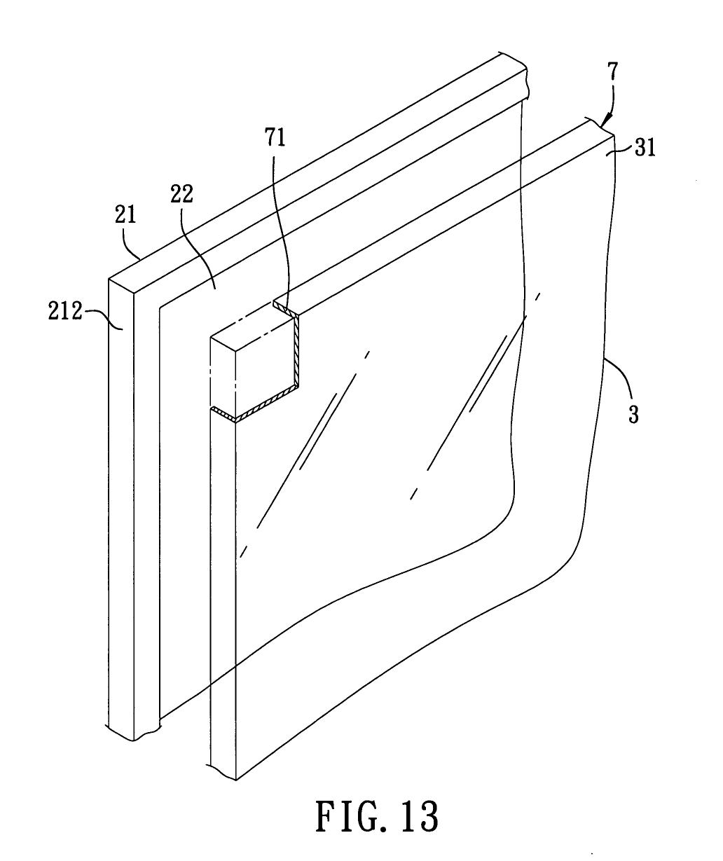

As shown in FIG. 13, the sixth preferred embodiment of this invention differs from the first preferred embodiment primarily in the configuration of the engaging unit 7. In this embodiment, the engaging unit 7 is formed integrally on the peripheral portions 31 of the reinforced protective transparent panel 3 and engages removably the panel base 21. In particular, the engaging unit 7 of this embodiment includes a flange unit 71 that extends integrally and continuously from the upper, lower, left and right peripheral portions 31 of the reinforced protective transparent panel 3 to surround the frame plates 212 of the panel base 21, thereby preventing undesired displacement of the reinforced protective transparent panel 3 relative to the panel base 21. Preferably, a fibrous agent is coated between the flange unit 71 and the frame plates 212 to increase traction therebetween.

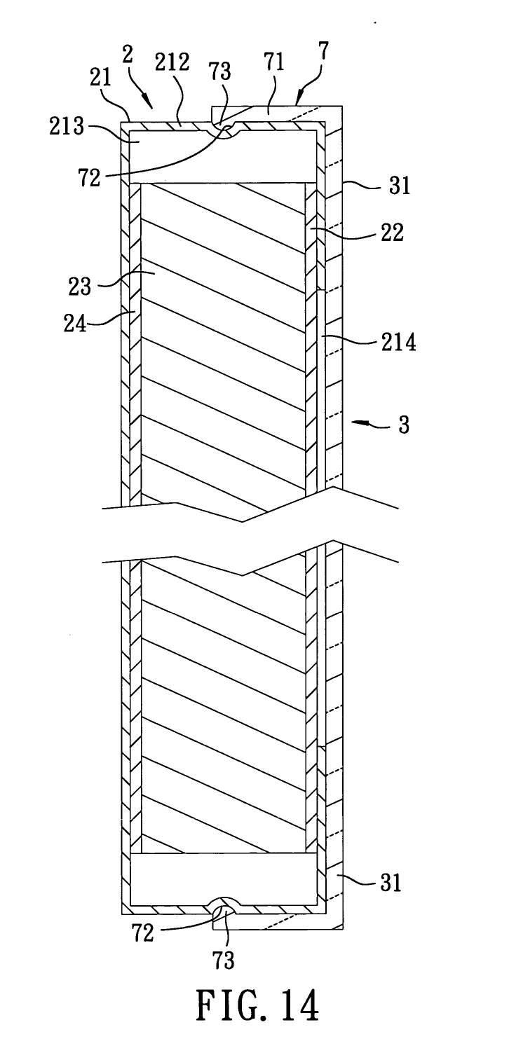

As shown in FIG. 14, the seventh preferred embodiment of this invention is similar to the sixth preferred embodiment, the main difference residing in that the flange unit 71 is formed with a rib unit 72, whereas the frame plates 212 of the panel base 21 are formed with a groove unit 73 to engage the rib unit 72.

Note that, in yet another embodiment of this invention, the positions of the rib unit 72 and the groove unit 73 on the flange unit 71 and the panel base 21 may be interchanged.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A liquid crystal display panel device, comprising:
a face panel unit including a hollow panel base, front and rear transparent electrode layers disposed in said panel base, and a liquid crystal active layer disposed in said panel base between said front and rear transparent electrode layers and operably associated with said front and rear transparent electrode layers;
a reinforced protective transparent panel disposed in front of said face panel unit and parallel to said front transparent electrode layer for protecting said face panel unit, said reinforced protective transparent panel having at least one pair of opposing peripheral portions; and
an engaging unit including at least two engaging members provided on at least two opposite sides of said panel base, each of which retains removably a respective one of said peripheral portions of said reinforced protective transparent panel on said panel base.

2. The liquid crystal display panel device as claimed in claim 1, wherein each of said engaging members is formed with a retaining groove to engage the respective one of said peripheral portions of said reinforced protective transparent panel.

3. The liquid crystal display panel device as claimed in claim 2, wherein said peripheral portions of said reinforced protective transparent panel include upper, lower, left and right peripheral portions,
at least three of said upper, lower, left and right peripheral portions being retained removably on said panel base by respective ones of said engaging members.

4. The liquid crystal display panel device as claimed in claim 2, wherein said peripheral portions of said reinforced protective transparent panel include upper and lower peripheral portions that are retained removably on said panel base by respective ones of said engaging members.

5. The liquid crystal display panel device as claimed in claim 2, wherein said peripheral portions of said reinforced protective transparent panel include left and right peripheral portions that are retained removably on said panel base by respective ones of said engaging members.

6. The liquid crystal display panel device as claimed in claim 2, wherein each of said engaging members has a mounting portion mounted to said panel base, and a retaining portion that extends from said mounting portion and that is formed with said retaining groove.

7. The liquid crystal display panel device as claimed in claim 6, wherein said retaining portion includes a pair of retaining plates that define said retaining groove therebetween.

8. The liquid crystal display panel device as claimed in claim 6, wherein said engaging unit further includes screw fasteners for mounting removably said mounting portions of said engaging members to said panel base.

9. The liquid crystal display panel device as claimed in claim 2, wherein each of said engaging members has a connecting portion, a retaining portion that extends from said connecting portion and that is formed with said retaining groove, and a resilient anchoring portion that extends from said connecting portion and that engages said panel base.

10. The liquid crystal display panel device as claimed in claim 9, wherein said resilient anchoring portion includes a pair of spring arms, each of which has a distal barb end to engage removably said panel base.

11. The liquid crystal display panel device as claimed in claim 2, wherein said retaining groove has a non-rectangular shape and is defined by a first inner wall surface, a second inner wall surface extending inclinedly from said first inner wall surface, a third inner wall surface extending from said second inner wall surface and transverse to said first inner wall surface, and a fourth inner wall surface extending from said third inner wall surface and parallel to said first inner wall surface.

12. The liquid crystal display panel device as claimed in claim 2, wherein said retaining groove has a non-rectangular shape and is defined by a first inner wall surface, a second inner wall surface extending from and transverse to said first inner wall surface, a third inner wall surface extending inclinedly from said second inner wall surface, and a fourth inner wall surface extending from said third inner wall surface and parallel to said first inner wall surface.

13. The liquid crystal display panel device as claimed in claim 2, wherein said retaining groove has a non-rectangular shape and is defined by a first inner wall surface, a second inner wall surface extending inclinedly from said first inner wall surface, a third inner wall surface extending from said second inner wall surface and transverse to said first inner wall surface, a fourth inner wall surface extending inclinedly from said third inner wall surface and disposed opposite to said second inner wall surface, and a fifth inner wall surface extending from said fourth inner wall surface and parallel to said first inner wall surface.

14. The liquid crystal display panel device as claimed in claim 1, wherein each of said engaging members has a mounting portion mounted to said panel base, and a retaining portion that extends transversely from said mounting portion and that presses the respective one of said peripheral portions of said reinforced protective transparent panel against said panel base.

15. The liquid crystal display panel device as claimed in claim 14, wherein said engaging unit further includes screw fasteners for mounting removably said mounting portions of said engaging members to said panel base.

16. A liquid crystal display panel device comprising:
a face panel unit including a hollow panel base, front and rear transparent electrode layers disposed in said panel base, and a liquid crystal active layer disposed in said panel base between said front and rear transparent electrode layers and operably associated with said front and rear transparent electrode layers;
a reinforced protective transparent panel disposed in front of said face panel unit and parallel to said front transparent electrode layer for protecting said face panel unit, said reinforced protective transparent panel having at least one pair of opposing peripheral portions; and
an engaging unit formed integrally on said peripheral portions of said reinforced protective transparent panel and engaging removably said panel base.

17. The liquid crystal display panel device as claimed in claim 16, wherein said peripheral portions of said reinforced protective transparent panel include upper, lower, left and right peripheral portions,
said engaging unit including a flange unit that extends integrally from at least three of said upper, lower, left and right peripheral portions.

18. The liquid crystal display panel device as claimed in claim 16, wherein said peripheral portions of said reinforced protective transparent panel include upper and lower peripheral portions,
said engaging unit including a flange unit that extends integrally from said upper and lower peripheral portions.

19. The liquid crystal display panel device as claimed in claim 16, wherein said peripheral portions of said reinforced protective transparent panel include left and right peripheral portions,
said engaging unit including a flange unit that extends integrally from said left and right peripheral portions.

20. The liquid crystal display panel device as claimed in claim 16, wherein said engaging unit includes a flange unit that extends integrally from said peripheral portions of said reinforced protective transparent panel and that is disposed to surround said panel base,
one of said flange unit and said panel base being formed with a rib unit,
the other of said flange unit and said panel base being formed with a groove unit to engage said rib unit.
